(19) United States
(12) Patent Application Publication
(10) Pub. No.: US 2005/0136170 A1
(43) Pub. Date: Jun. 23, 2005

(54) Beverages and their preparation

(75) Inventors: Kai Grebenkamper, Vlaardingen (NL); Reinhard Kohlus, Vlaardingen (NL); Krassimir Petkov Velikov, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Slim-Fast Foods Company, Division of Conopco, Inc.

(21) Appl. No.: 11/017,478

(22) Filed: Dec. 20, 2004

(30) Foreign Application Priority Data
Dec. 23, 2003 (GB) 0329833.8

(51) Int. Cl. A23L 1/30

(52) U.S. Cl. 426/590

(57) ABSTRACT

A process for making a powdered precursor for preparing an acidic beverage upon admixture of the powdered precursor with a liquid, the process comprising the steps: (a) preparing a first slurry comprising a protein source and a polysaccharide stabiliser, said first slurry having a neutral or an acidic pH; (b) adjusting the pH of the first slurry, if necessary, to a value in the range of from 5.5 to 7.5, preferably 6 to 7.5, more preferably from 6 to 7; and (c) spray drying the first slurry after step (a) or step (b).

### FIELD OF THE INVENTION

The present invention relates to beverages, especially beverages having a pH at or close to neutral and processes for preparing them. The beverages may be in powder form for conversion into a drink by the addition of a liquid.

### BACKGROUND OF THE INVENTION

At neutral or mildly acidic pH, protein used in instant powdered drinks tends to sediment, due to poor dispersibility, leading to phase separation and consumer perception of chalkiness and sandiness. In order to produce stable acidic foods, different stabilisers have been used to prevent coagulation and precipitation of protein particles. At higher concentrations of stabiliser, unwanted effects such as phase separation, precipitation, etc are observed. In addition, all stabilisers increase viscosity when used, and are therefore not suited to the tastes of today's consumers who prefer low viscosity and light food textures.

It is also known to granulate powdered soybean protein in a fluidized bed agglomerator whilst spraying-on an aqueous solution of carbohydrate, as disclosed in US-A-2002/146487 and US-A-2003/124226.

Stabilisers such as carrageenan, sodium carboxymethylcellulose (CMC-Na), propylene glycol alginate ester (PGA), water-soluble soybean polysaccharides (SSP), and beet-derived pectin (BD-pectin) have normally been used in ready-to-drink products, either alone or in combination (including mixtures with other polysaccharides) for production of ready-to-drink acidic protein foods in order to prevent phase separation with resultant chalkiness and sandiness caused by protein particles.

Thus, there remains a need to provide beverages around neutral pH or mildly acidic pH, which are either in liquid, drinkable form or which can be made into a drinkable composition by dispersing in a liquid, the drinkable compositions having a low viscosity, preferably in the range of 5 to 50 mPas at a shear rate of 0.1 s⁻¹ or at 10 s⁻¹ beverages avoid the drawbacks of phase separation, chalkiness and sandiness due to the protein particles.

### SUMMARY OF THE INVENTION

According to a first aspect of the invention there is provided a process for making a powdered precursor for preparing a neutral or midly acidic beverage upon admixture of the powdered precursor with a liquid, the process comprising the steps:
(a) preparing a first slurry comprising a protein source and a polysaccharide stabiliser, said first slurry having a neutral or mildly acidic pH;
(b) adjusting the pH of the first slurry, if necessary, to a value in the range of from 5.5 to 7.5, preferably from 6 to 7.5, more preferably from 6 to 7; and
(c) spray drying the first slurry after step (a) or step (b).

According to a second aspect of the invention there is an acidic beverage made by the admixture of a liquid, preferably an aqueous liquid and a powdered precursor made by the process of the first aspect of the invention. An aqueous liquid is one which contains at least some water, preferably at least 10%, more preferably at least 25%, most preferably at least 50% by weight of water. The term also includes substantially pure water such as tap water.

In a particularly preferred embodiment, the inventors have ground that the above-mentioned problems can be overcome by spray drying of solutions of proteins and stabilisers at nearly neutral or mildly acidic pH.

### DETAILED DESCRIPTION OF THE INVENTION

The beverage powder precursors must be mixed with a liquid in order to form a composition which is suitable for a consumer to drink. Any suitable liquid can be used, but preferred examples are water and milk. “Milk” also includes flavoured milk drinks.

Preferably a second slurry is prepared comprising the protein source, a third slurry is prepared comprising the polysaccharide stabiliser and the second and third slurries are admixed to provide said first slurry.

As used herein, the term “neutral or mildly acidic” preferably means a pH from 5.5 to 8, more preferably from 6 to 7. In any range wherein the lower value is “from 6”, this may be replaced by “from more than 6” or by “from 6.00001” or “from 6.01”.

If the first slurry has a pH range outside the target range of from 6 to 7.5 or outside the preferred target range of from 6 to 7, then before spray drying in step (c), in step (b) its pH is adjusted by conventional means.

The Protein Source

The protein source may comprise any specific type of protein, e.g. animal, in particular dairy protein, or plant protein.

Preferably the protein source provides at least some plant protein, for example soy protein, pea protein or lupin protein, or mixtures thereof. These proteins can be intact or hydrolysed, and can be used separately or in combination with each other.

The total amount protein to be used may be generally about 0.5 to 10 wt %, preferably 0.5 to 4 wt %, and preferably around 2.7% wt (e.g. 4 g in a 150 g serving) with respect to the final product.

In relation to the first slurry, the amount of protein source in the second slurry could for example be from 5 to 20 wt %.

The Polysaccharide Stabiliser

A wide range of polysaccharides can be used as stabilisers, particularly polysaccharide gums. However, preferred stabilisers are selected from locust bean gum, tamarind seed polysaccharide, gellan gum, xanthan gum, guar gum, tara gum, gum arabic, kalaya gum, carrageenan, agar soybean polysaccharides and mixtures thereof.

One or more auxiliary non-polysacccharide stabilisers may be used in addition to the polysaccharide stabiliser(s). In particular, preferred auxiliary stabilisers are glycol alginate esters, methoxy pectin (HM-pectin), sodium carboxymethylcellulose (CMC-Na), propylene glycol alginate ester (PGA), and beet-derived pectin (BD-pectin). These may be used alone or in combination. The most preferred stabilisers are guar gums.

The amount of the stabiliser to be used may be generally about 0.05-10% wt, and preferably 0.05-2 wt %, with respect to the final beverage product, but these ranges do not restrict the scope of the invention because they may vary depending on differences in the protein concentration. The weight ratio of protein:stabiliser is preferably from 5:1 to 50:1 more preferably from 10:1 to 30:1.

The amount of stabiliser in the first slurry is preferably from 0.02 to 20 wt %, e.g. 5 to 20 wt %.

With regard to the third slurry, the amount of stabiliser in the third slurry is preferably from 0.1 to 20 wt %, preferably from 0.1 to 3 wt %.

Carbohydrate

Preferably, carbohydrate is included in the first slurry, most preferably introduced via the protein source-containing second slurry. Preferred carbohydrates include sugars, starches, and maltodextrin.

Other Ingredients

The powder preferably further contains emulsifier, organic acid (such as lactic, malic or citric) and oil fat and is fortified with minerals, vitamins, etc. Once dispersed in a liquid such as water or milk, the drink is preferably stable against coagulation and phase separation for at least 30 minutes.

Product Form

The powdered precursor may be one adapted to make any desired neutral or mildly acidic beverages, upon addition of a suitable liquid such as water or milk.

For the spray drying operation, the feed may be a stable solution of the ingredients with a dry matter content between 10 and 50%, preferably between 30 and 40% (m/m). This slurry is spray dried in a so-called spray-drier, resulting in fine particulate matter. A spray dryer is a system where the feed liquid is atomised by means of any type of atomiser, i.e. rotary, two or one phase nozzle, and subsequently dried to from particulate matter. Where the particle size is between 5 and 400 μm, eg between 5 and 100 μm. To produce a dry powder, the spray tower is preferably operated at a temperature of from 150 to 250° C., depending on the dry matter content and tower loading (mass flow ratio slurry to air). The resulting powder will be typically hydrophobic. Due to its fineness and hydrophobicity the material is typically difficult to disperse in water without lump formation. An additional agglomeration or granulation step increases the particle size of each particle. The initial particle will have a d_{4,3} average particle diameter of from 5 μm to 100 μm, e.g. from 5 μm to 35 μm whereas the preferred d_{4,3} average particle size ex granulator lies preferably between 50 and 600 μm, more preferably between 150 and 400 μm. This improve the dispersibility so far that it can be easily use in a powdered drink mix, where the spray-dried powder is used, in a mixture with other powders. The agglomeration preferably takes place in a fluid bed type of agglomerator, like a Fielder-Aeromatic type. The binder fluid is preferably plain water. It is advantageous to agglomerate a mixture of the spray-dried material with a carbohydrate like sucrose or maltodextrin or an easily dissolving salt. Alternatively any other type of agglomerator can be used, e.g.:
high shear mixer granulator e.g. Schugi type granulator or Loedige ploughshare type,
pressure granulators, e.g. Bepex basket extruder type granulators, or
steam granulators.

The most favourable technique is the use of a combined spray-drier/fluidised bed system, where the powder from the spray drier is directly granulated. Such a system would be for example a Fluidized Spray Dryer or a Multistage Spray Dryer form GEA Niro A/S. The agglomeration could be just due to the remaining cohesiveness of the powder due to steam treatment or water spray on, with or without addition of easily water soluble material as binder. Such material would be carbohydrates, salts or polymers known as binder.

The addition of lecithin can improve the wetability and dispersability of the powder.

The present invention will now be explained in more detail by way of the following non-limiting examples. Throughout these examples, the parts and percentages are based on weight unless otherwise specified.

### EXAMPLES

As analytical methods viscosimetry, particle sizing and phase separation measurements were used. The used methods will be explained in the following chapter.

The viscosity was tested in a cone-plate geometry of a rotational rheometer. Temperature was set to 20° C. The data are taken from the down curve of a flow curve hysteresis. 10 l/s and 50 l/s were chosen as relevant shear rates.

The stability of the beverages was tested by measuring the phase-separated volume in a cylinder as well as visually. When visually clear flocs were determined the system was classified as unstable.

The surface weighted volume mean diameters D3,2 and D4,3 of the particles in the beverage were determined by laser diffraction to get a value for sandiness.

The amount of unstable dispersed mater was measured by centrifugation of the final product for 20 minutes at 2800 g and 20° C. The percentage of the sediment (sediment/total mass×100) was measured after 5 minutes of dripping out the water.

### Examples 1-4

These examples comprise, respectively, preparation of four powdered beverage precursors by spray drying and agglomeration.

The used material was a standard spray dried skim milk powder as source for a milk protein. The used spray dried was in this case a Niro Mobile Minor. The soy protein originates from a soy protein isolate: FXP219 D ex Solae, as pea protein Pisane HD NO5 ex Cosucrua was used. The stabiliser are: Blanose 7LF ex Hercules (SCMC 7), k-Carragenan (Genugel X-0909 ex CP Kelco), Vidocreme A type of guar gum ex Unipektin (guar). The used maltodextrin is a DE 12 maltodextrin ex Rouquette (Glucidex IT 12).

TABLE 1
Examples with different proteins and stabilisers.

| Example | | 1 | 2 | 3 | 4 |
|---|---|---|---|---|---|
| Protein source | | soy | soy | pea | soy/SMP |
| Type | | k-Carraghenan | SCMC 7 | Guar | Guar |
| Protein powder | SMP | 0.0% | 0.0% | 0.0% | 16.9% |
| | Soy | 30.0% | 30.0% | 22.4% | 28.7% |
| | Pea | 0.0% | 0.0% | 0.0% | 0.0% |
| Maltodextrin | MD12 | 69.4% | 62.0% | 76.0% | 52.8% |
| Citric acid | CA | 0.0% | 4.0% | 0.0% | 0.0% |
| Biopolymer | Stabiliser | 0.6% | 2.0% | 2.0% | 1.6% |
| T in | [° C.] | 159 | 160 | 161 | 160 |
| T out | [° C.] | 83 | 83.7 | 81.9 | 80 |
| Total solids | % | 10% | 20% | 20% | 20% |
| content in final product | | | | | |
| pH | | 7.02 | 5.6 | 5.89 | 6.7 |
| D3,2 wet 5 min. | micron | 0.26 | 5 | 20.7 | 0.35 |
| D4,3 wet 5 min. | micron | 9.4 | 12.1 | 50 | 58.3 |
| Phase | % | 0 | 0 | 0 | 0 |
| separation 15 min. | | | | | |
| Stable after | | yes | slightly | yes | yes |
| 15 min. | | | flocculated | | |
| Phase | % | 0 | 0 | 1 | 0 |
| separation 45 min. | | | | | |
| Stable after | | yes | slightly | yes | yes |
| 45 min. | | | flocculated | | |
| eta 10 1/sec. 5 min | mPas | 28 | 30 | 35 | 31 |
| eta 50 1/sec. 5 min | mPas | 22 | 28 | 34 | 29 |
| Centrifugation | % | 13.6 | 22 | 35 | 7.7 |

Example 4 is agglomerated in a so-called multistage drier, where a fluid bed is integrated in the spray tower. It was possible to disperse the agglomerated powder by adding it to water and by stirring the mass for 20 seconds with a spoon. This shows that the powder has good instant properties. The non-agglomerated samples (1-3) showed less ideal instant properties and they were dispersed shortly by a blender type of equipment for 15 sec.

Reference samples were produced for comparison to the above examples.

TABLE 2
Reference samples

| Example | | Ref 1 | Ref 2 | Ref 3 | Ref 4 |
|---|---|---|---|---|---|
| Protein source | | Soy | Soy | Pea/Guar | Soy/Guar |
| Protein powder | SMP | 0.0% | 0.0% | 0.0% | 0.0% |
| | Soy | 30.0% | 30.0% | 0.0% | 30.0% |
| | Pea | 0.0% | 0.0% | 25.0% | 0.0% |
| Maltodextrin | MD12 | 70.0% | 67.0% | 75.0% | 70.0% |
| Citric acid | CA | 0.0% | 3.0% | 0.0% | 2.0% |
| Biopolymer | | 0.00% | 0.0% | 2.00% | 2.00% |
| Total solids content | % | 20.0% | 20.0% | 20.0% | 20.0% |
| in final product | | | | | |
| pH | | 7.08 | 5.5 | 6.01 | 6.99 |
| D3,2 wet 5 min. | micron | 13.3 | 5.5 | 27.1 | 0.7 |
| D4,3 wet 5 min. | micron | 21.7 | 25.5 | 85 | 149.6 |
| Phase separation 15 min. | % | 1 | 0 | 0 | 1 |
| Stable after 15 min. | | yes | slightly | yes | yes |
| | | | flocculated | | |
| Phase separation 45 min. | % | 10 | 0.5 | 2 | 10 |
| Stable after 45 min. | | slightly | slightly | yes | slightly |
| | | flocculated | flocculated | | flocculated |
| eta 10 1/sec. 5 min | mPas | 9.5 | 58 | 61 | 246 |
| eta 50 1/sec. 5 min | mPas | 10.5 | 29 | 61 | 360 |
| centrifugation | % | 19.5 | 36.7 | 32.9 | 6.6 |

1. A process for making a powdered precursor for preparing a neutral or mildly acidic beverage upon admixture of the powdered precursor with a liquid, the process comprising the steps:
(a) preparing a first slurry comprising a protein source and a polysaccharide stabiliser, said first slurry having a neutral or mildly acidic pH;
(b) adjusting the pH of the first slurry, if necessary, to a value in the range of from 5.5 to 7.5, preferably from 6 to 7.5, more preferably from 6 to 7; and
(c) spray drying the first slurry after step (a) or step (b).

2. The process of claim 1, wherein a second slurry is prepared comprising the protein source, a third slurry is prepared comprising the stabiliser and the second and third slurries are then mixed to form said first slurry.

3. The process of claim 1, wherein carbohydrate is added to at least one slurry, preferably the second slurry as recited.

4. The process of claim 1, wherein the polysaccharide stabiliser is selected from locust bean gum, tamarind seed polysaccharide, gellan gum, xanthan gum, guar gum, tara gum, gum arabic, kalaya gum, carrageenan, agar soybean polysaccharides and mixtures thereof.

5. The process of claim 1, further comprising the step of subjecting the slurry or any or all slurries to a heat treatment, preferably in the range of from 40° C. to 80° C.

6. The process of claim 1, further comprising the step of homogenising the slurry or any or all of the slurries.

7. The process of claim 1, further comprising agglomerating the spray dried product of step (c).

8. The process of claim 1, wherein in step (a) the first slurry has a pH above the isoelectric point of the protein, preferably a pH above 6.

9. The process of claim 2, wherein the stabiliser in the third slurry is neutral or is negatively charged.

10. The process of claim 1, wherein the protein source comprises a plant protein, animal protein or mixtures thereof.

11. The process of claim 10, wherein the plant protein is selected from soy protein, pea protein or lupin protein or mixtures thereof, and/or the animal protein is selected from dairy protein.

12. The process of claim 2, wherein the amount of stabiliser in the third slurry is from 0.01 to 20 wt %, preferably from 0.1 to 20 wt %.

13. The process of claim 1, wherein in step (d) one or more further ingredients are added to the mixture of slurries, these ingredients preferably being selected from fat, emulsifiers and organic acids.

14. A neutral or mildly acidic beverage made by the admixture of a liquid, preferably an aqueous liquid and a powdered precursor made by a process for making a powdered precursor for preparing a neutral or mildly acidic beverage upon admixture of the powdered precursor with a liquid, the process comprising the steps:
(a) preparing a first slurry comprising a protein source and a polysaccharide stabiliser, said first slurry having a neutral or mildly acidic pH;
(b) adjusting the pH of the first slurry, if necessary, to a value in the range of from 5.5 to 7.5, preferably from 6 to 7.5, more preferably from 6 to 7; and
(c) spray drying the first slurry after step (a) or step (b).

15. The neutral or mildly acidic beverage of claim 14, which contains stabiliser at a level of from 0.05 to 10 wt %.

16. The neutral or acidic beverage of claim 14, which contains protein at a level of from 0.5 to 10 wt %.

17. The neutral or mildly acidic beverage of claim 14, which has a viscosity of from 5 to 50 mPas at a shear rate of 0.1 s⁻¹ or of 10 s⁻¹.
